(19) United States
(12) Patent Application Publication
(10) Pub. No.: US 2006/0094514 A1
(43) Pub. Date: May 4, 2006

(54) Flexible coupling

(75) Inventor: Douglass L. Blanding, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 10/977,460

(22) Filed: Oct. 29, 2004

(51) Int. Cl. F16D 3/52

(52) U.S. Cl. 464/101

(57) ABSTRACT

A flexure coupling (40) between a drive member (30) and a load member (32) has a plurality of folded sheet flexures (20). Each folded sheet flexure (20) is coupled to the drive member (30) on one side of a fold (36) and coupled to the load member (32) on the opposite side of the fold (36).

### CROSS REFERENCE TO RELATED APPLICATIONS

Reference is made to commonly-assigned copending U.S. patent application Ser. No. ______ (Attorney Docket No. 89022/NAB), filed herewith, entitled “COUPLING APPARATUS” by Douglass Blanding, the disclosure of which is incorporated herein.

### FIELD OF THE INVENTION

This invention generally relates to mechanical couplings and more particularly relates to a coupling for rotational displacement between a drive member and a load member.

### BACKGROUND OF THE INVENTION

Flexible shaft couplings are used in numerous applications for transmitting rotational movement, or rotational constraint, between a drive member and a load member, where the drive and load members can be angularly or laterally misaligned to some degree. Among the many solutions for rotational transmission between misaligned components include the Cardan cross-style coupling invented in the sixteenth century by Girolamo Cardano and widely used in industrial and vehicular applications, allowing shaft misalignment of as much as 10 degrees or more. The constant velocity (CV) joint is another type of flexible shaft coupling that advantageously provides unity velocity transmission between misaligned shafts. Other flexible shaft coupling solutions include bellows couplings, as described in a number of patents including U.S. Pat. Nos. 6,514,146 (Shinozuka); 6,328,656 (Uchikawa et al.); and 6,695,705 (Stervik). Other types of couplings use disc-shaped structures as disclosed in U.S. Pat. No. 5,041,060 (Hendershot). Commercially available flexible couplings include power transmission couplings using HELI-CAL® Flexure technology, manufactured by Helical Products Company, Inc., Santa Maria, Calif., USA.

Couplings can be broadly classified in terms of their constraints and degrees of freedom according to the standard orthogonal XYZ coordinate system shown in FIG. 1. Six degrees of freedom are of interest: translation in x, y, and z and rotation about these axes, θx, θy, and θz. A coupling apparatus 10 provides a constraint to movement along or about at least one of the XYZ axes and a degree of freedom along or about one or more of the other axes. For the purposes of general description, coupling apparatus 10 can be considered to couple a drive member 30 with a load member 32. It is instructive to note that the terms “drive” and “load” are somewhat arbitrary as used in the present application. That is, the designation of drive member 30 and load member 32 simply serves to distinguish the two elements that are coupled; the particular mechanism in which coupling apparatus 10 is used determines whether “drive” and “load” are the most appropriate terms.

Preferred operating characteristics of shaft couplings include an appropriate level of torsional or wind-up stiffness and zero backlash. Conventional shaft coupling solutions, particularly those providing CV behavior, are typically complex and costly. The level of complexity and corresponding cost depend, in large part, on the application. Shaft couplings for automotive and industrial applications are, of course, relatively complex and expensive. Couplings used for transmitting torque from small motors or couplings used with instrumentation, meanwhile, can be much cheaper. However, there remains a need for flexible coupling solutions that perform well, are constructed using a minimum number of parts, and are adaptable to a number of different coupling applications. In addition, a low-cost CV coupling would be particularly advantageous for a range of applications including miniaturized actuators and instruments, small and intermediate sized motors, and motion control or stabilizing apparatus.

### SUMMARY OF THE INVENTION

It is an object of the present invention to provide coupling that provides high rotational or wind-up stiffness and allows variable axial movement between a drive and a load member. With this object in mind, the present invention provides a coupling between a drive member and a load member, the coupling comprising a plurality of folded sheet flexures, wherein each folded sheet flexure is:
i) coupled to the drive member on one side of a fold; and
ii) coupled to the load member on the opposite side of the fold.

It is a feature of the present invention that it employs an arrangement of folded sheet flexures for coupling drive and load members.

It is an advantage of the present invention that it provides a flexible coupling solution that can be constructed from low cost shaft and flexure components. The coupling mechanism of the present invention can be suitably scaled in size to meet the requirements for small-scale or large scale rotational coupling.

It is another advantage of the present invention that it provides a coupling that can be easily attached to a drive or load mechanism using conventional fasteners or fittings.

It is yet another advantage of the present invention that it enables fabrication of a shaft coupling having zero backlash.

The apparatus of the present invention provides coupling that allows three degrees of freedom (z, θx, and θy) and is rigid in x, y, and θz.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a perspective block diagram view showing a generic coupling and establishing reference axes and terms used in the present application;

FIG. 2 is a perspective view showing a flexure coupling in one embodiment of the present invention;

FIG. 3 is a perspective view of a flexure coupling in one embodiment;

FIG. 4 is a perspective view of a flexure coupling showing key geometric relationships;

FIG. 5 is a front view of a flexure coupling showing key geometric relationships;

FIG. 6 is a perspective view of a coupling according to the present invention, related to conventional coordinate axes and showing degrees of freedom and constraint;

FIGS. 7A through 7D are perspective views of a flexure coupling, showing rotation wherein load and drive axes are not aligned in parallel;

FIG. 8 is a perspective view showing an alternate embodiment for the flexure coupling of the present invention;

FIG. 9 is a perspective view showing another alternate embodiment of a flexure coupling according to the present invention; and

FIG. 10 is a perspective view showing an alternate embodiment for the flexure coupling of the present invention.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

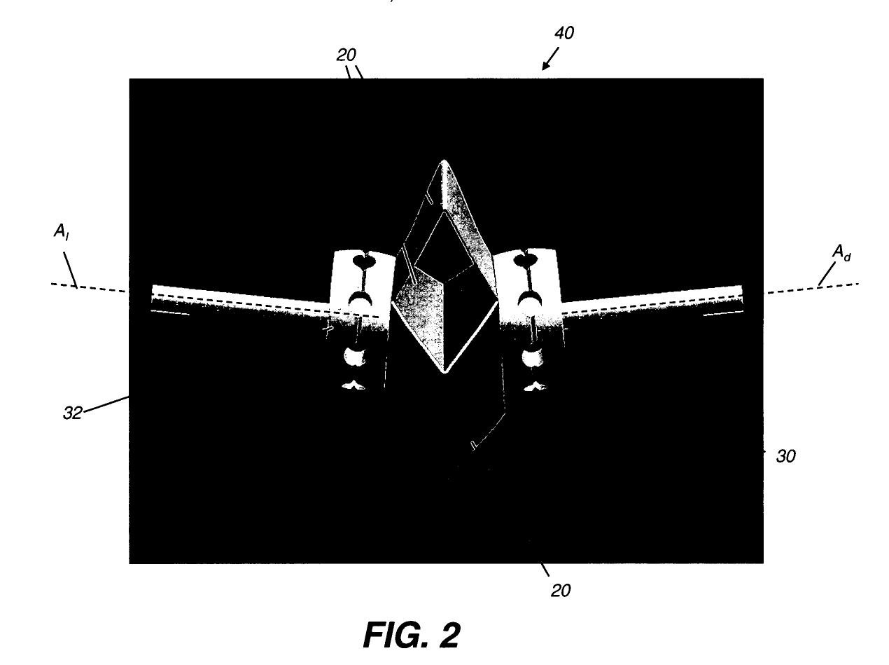

Referring to FIG. 2, there is shown a perspective view of a flexure coupling 40 according to one embodiment of the present invention. Flexure coupling 40 has a number of folded sheet flexures 20 for mechanical attachment between load member 32 and drive member 30. Flexure coupling 40 provides a suitable combination of constraints and degrees of freedom to operate where drive and load axes A_{d} and Aₗ are not aligned in parallel, as shown in FIG. 2. As was noted in the background section above, the terms “drive” and “load” are used in the broadest possible sense, simply to distinguish one coupled member from another. For some applications using motors or other rotational actuators, it may be required to couple rotational motion from a drive to a load element. Other applications, however, may instead take advantage of the inherent wind-up stiffness of flexure couplings 40.

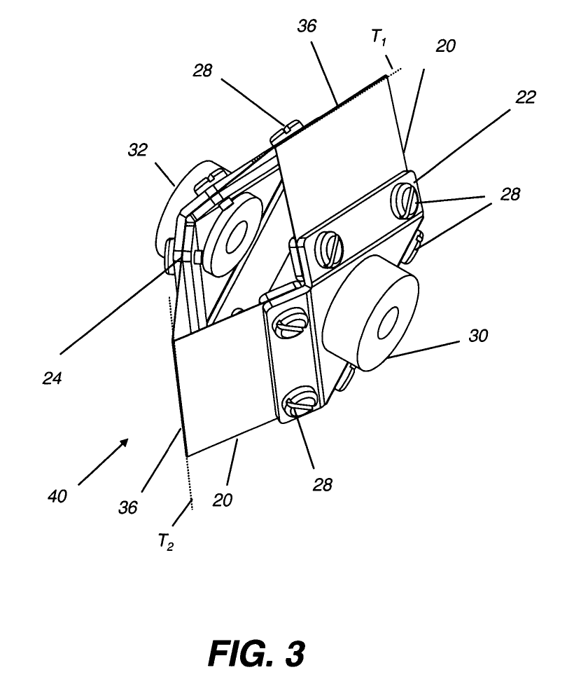

Referring to FIG. 3, the arrangement of flexure coupling 40 components in one embodiment is shown in more detail. For the configuration shown in FIG. 3, a plate 22, 24 is used on each side of flexure coupling 40, fastened to each folded sheet flexure 20 by screws 28 and using a flanged arrangement as shown. As can be readily appreciated by those skilled in the mechanical arts, any of a number of alternate components or methods could be employed for attachment of folded sheet flexure 20 to drive or load members 30 and 32. Possible alternate attachment means include welds or rivets, for example. In yet other embodiments, one or more folded sheet flexures 20 may simply be extended portions of surfaces of drive or load members 30 or 32 and thus not require fasteners at one side or the other. A fold 36 is formed in each folded sheet flexure 20. Folded sheet flexure 20 is coupled, on one side of fold 36, to drive member 30; the other side of folded sheet flexure 20 is coupled to load member 32.

Coupling 40 Structure and Geometry

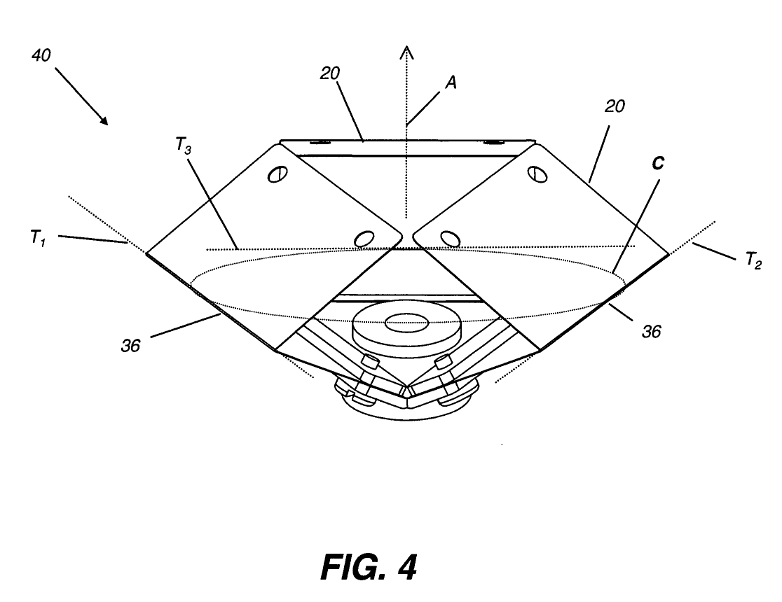

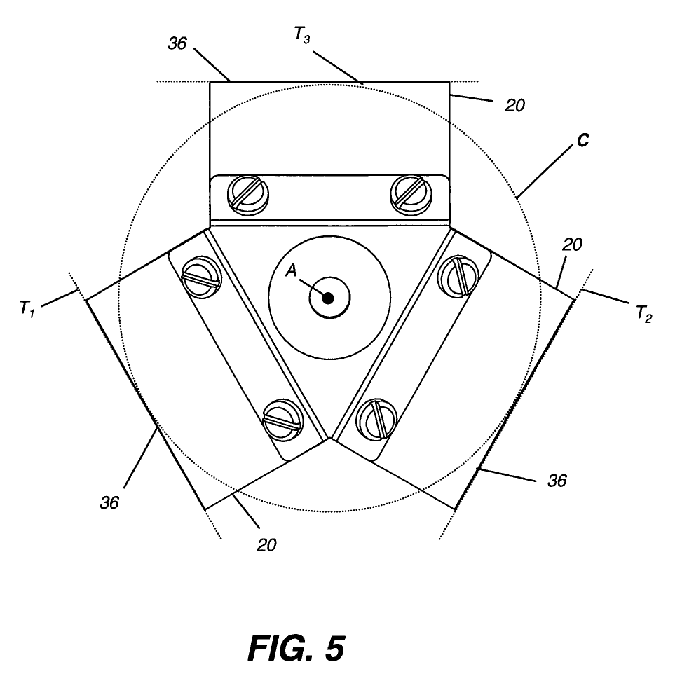

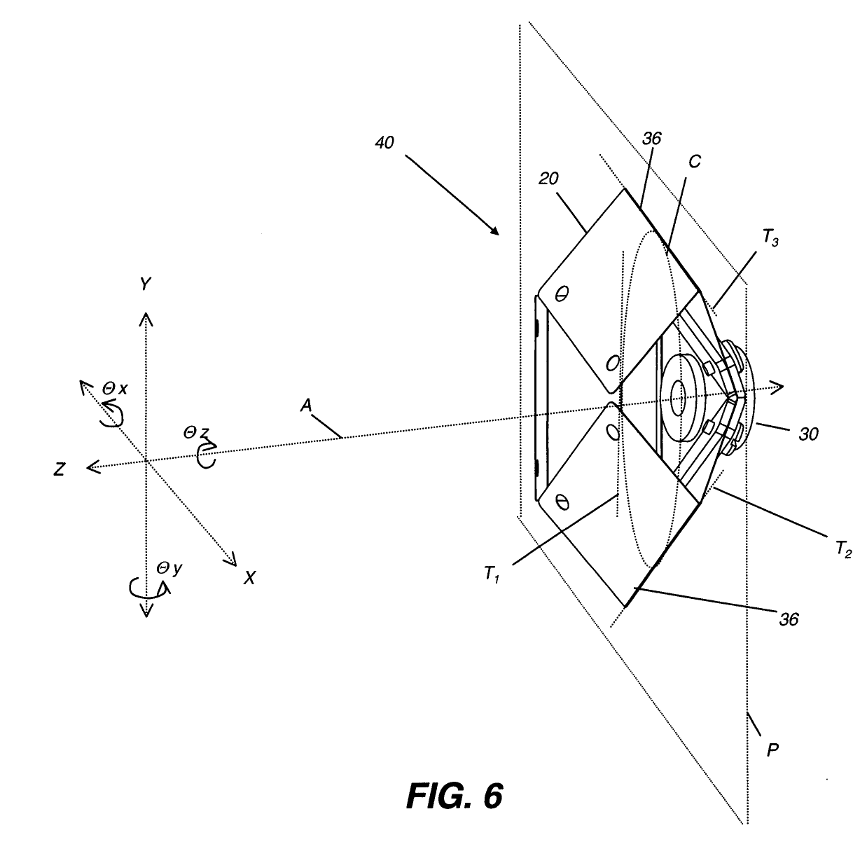

A detailed understanding of the structure and geometrical relationships of flexure coupling 40 components helps to better grasp its usefulness and capabilities. FIGS. 4, 5, and 6 show, from different views, the geometrical symmetry of folds 36 with respect to each other. The following observations can be made:
(i) Folds 36 are coplanar, as is best represented in FIG. 6, where the folds 36 are in a plane P;
(ii) Each fold 36 can be considered along a tangent line T₁, T₂, T₃ to a circle C, as is best shown in FIGS. 5 and 6, shown dotted;
(iii) Circle C is centered about an axis A between drive and load members 30 and 32, extending generally in the direction of coordinate axis z in FIG. 6. Axis A can be considered the rotational axis corresponding to θz rotation; and
(iv) Plane P and circle C are orthogonal to axis A.

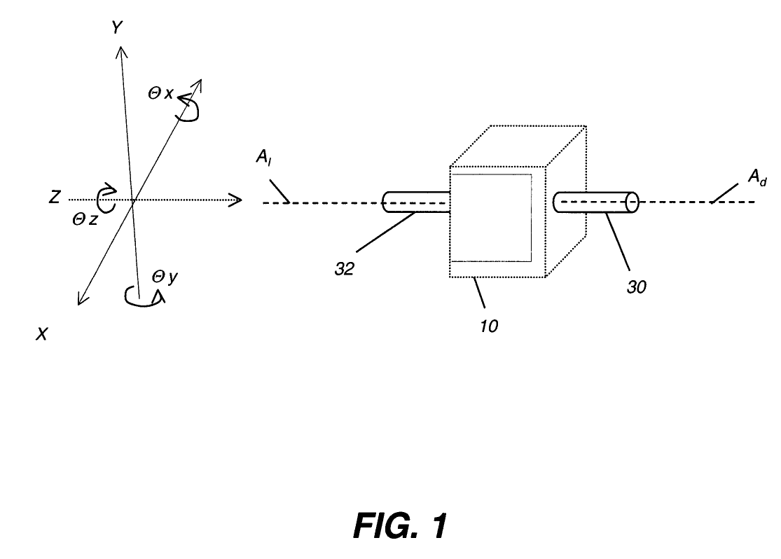

Using the geometrical arrangement described with reference to FIGS. 4 through 6 and summarized in (i) to (iv) above, flexure coupling 40 provides the following, as represented in FIGS. 1 and 6:
Constraint, with a high level of wind-up stiffness in x, y, and θz; and

Three degrees of freedom, or flexibility, specifically in z, θx, and θy.

The configuration using three folded sheet flexures 20 is particularly advantaged. Significantly, because of the trilateral symmetry of folded sheet flexures 20, plane P (FIG. 6) tends to align itself as the bisector of drive and load axes A_{d} and Aₗ (FIG. 1). This occurs even when drive and load axes A_{d} and Aₗ are angularly misaligned, as is shown in FIG. 2. This behavior gives flexure coupling 40 its “constant velocity” characteristic, so that flexure coupling 40, when fabricated in accordance with the geometry outlined in items (i)-(iv) above, is a CV coupling. This characteristic, along with its zero backlash, high wind-up stiffness, and high degree of flexibility for accommodating angular and shaft misalignment, make flexure coupling 40 ideally suited to a variety of coupling applications.

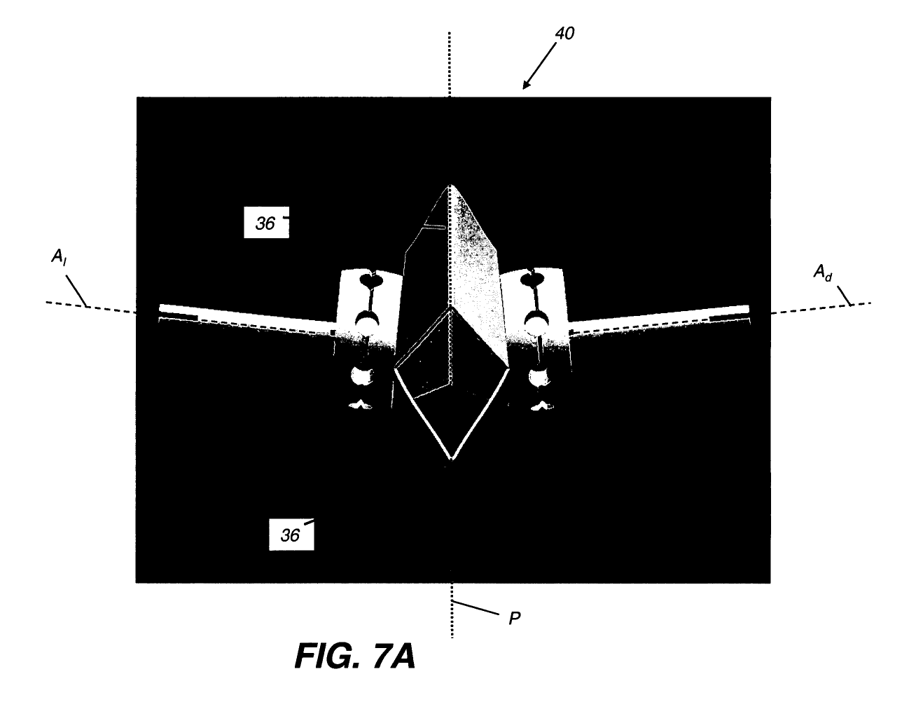

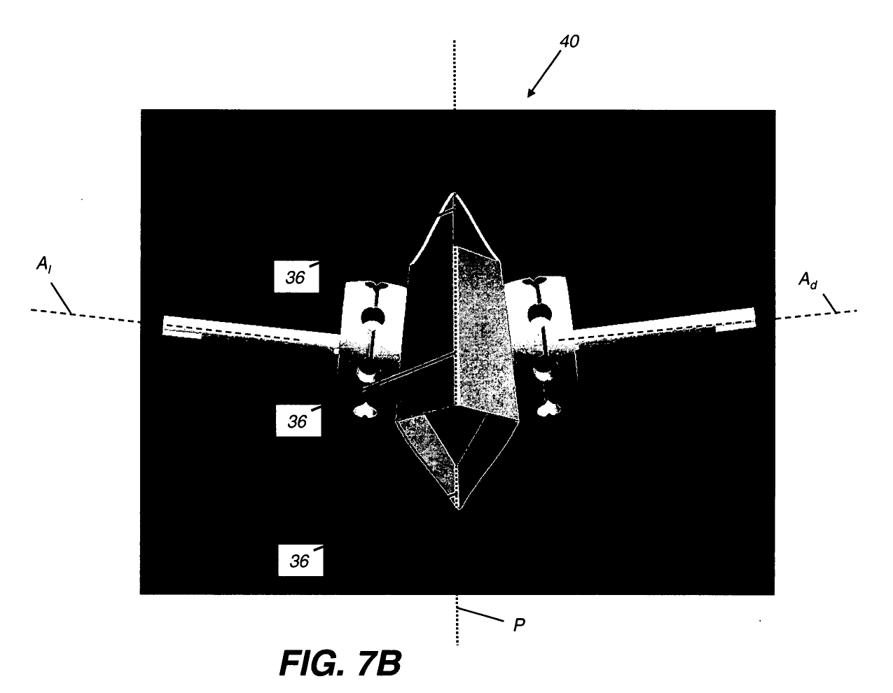

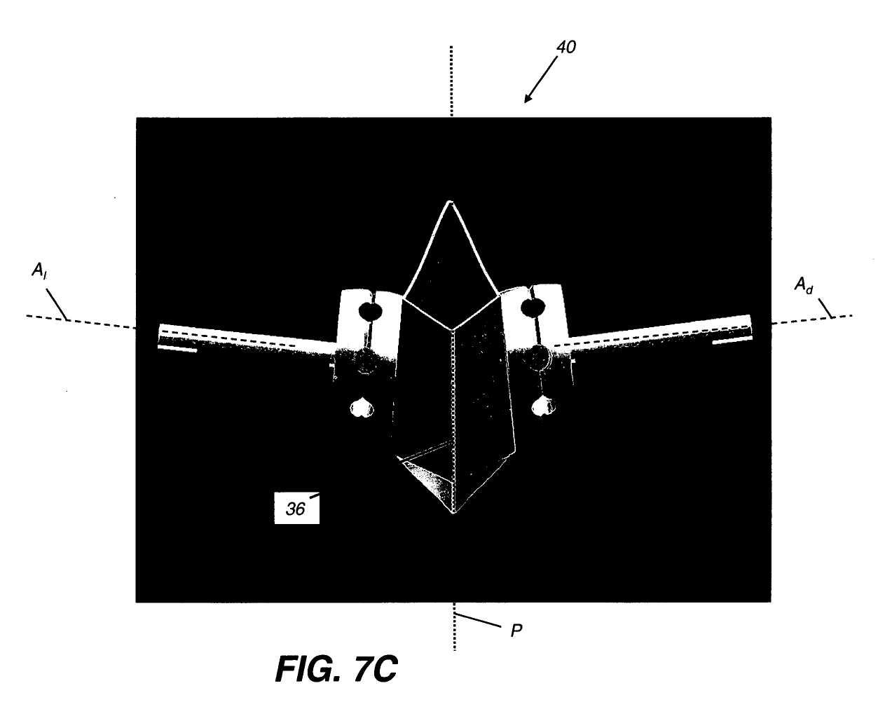

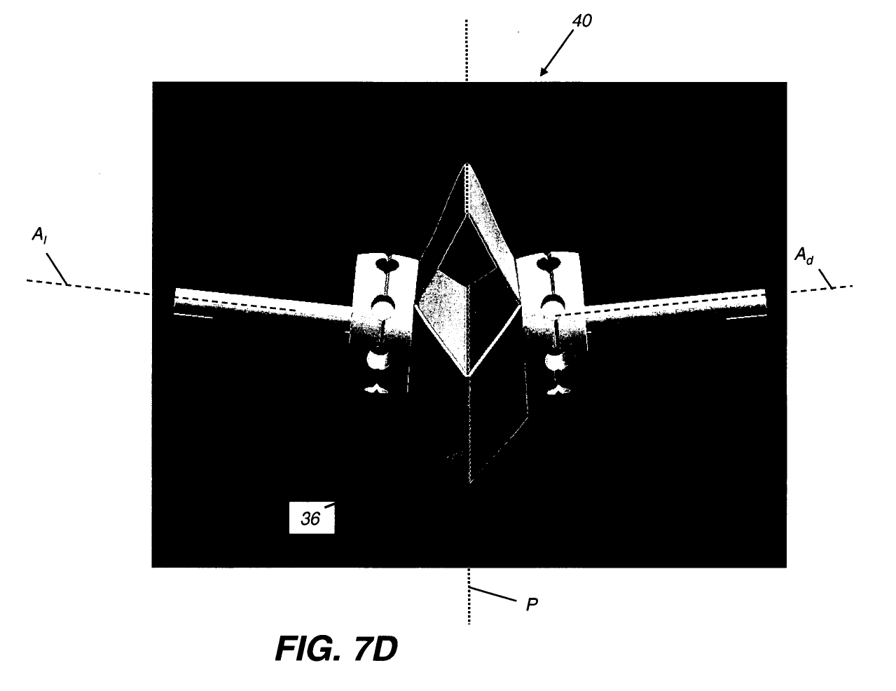

The sequence of FIGS. 7A-7D shows the behavior of flexure coupling 40 and the disposition of plane P during rotation. In FIGS. 7A-7D, drive and load axes A_{d} and Aₗ are not aligned in parallel. As folded flexure coupling 40 rotates, folds 36 remain coplanar in plane P, as was described hereinabove.

Alternate Embodiments

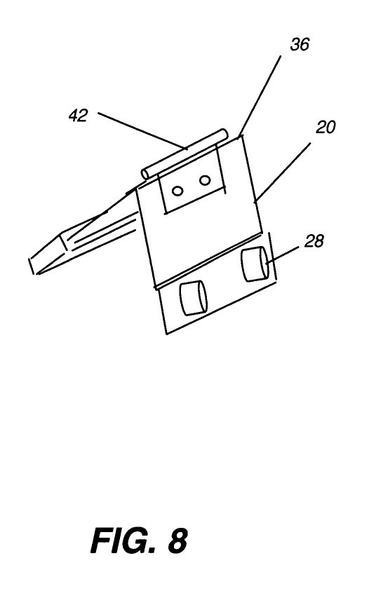

Folded sheet flexures 20 in FIGS. 2-7D are shown formed from a single sheet, typically of spring steel, creased at fold 36. However, alternate embodiments for folded sheet flexures 20 are possible and may be preferable for some applications. For example, two individual sheets of metal, plastic, or other sheet material could be joined, using adhesives, hardware, welds, or other fastening methods, effectively forming fold 36 at their juncture. Alternately, a hardware component such as a hinge 42 could be used for forming fold 36 in folded sheet flexure 20, as is shown in FIG. 8. Relative to configurations in which folded sheet flexure is formed by creasing a single sheet of metal, plastic, or other stiff material along fold 36, this hinged arrangement would not provide as much wind-up stiffness along the z-axis, however. Additional support fasteners would also be required for an arrangement such as that shown in FIG. 8.

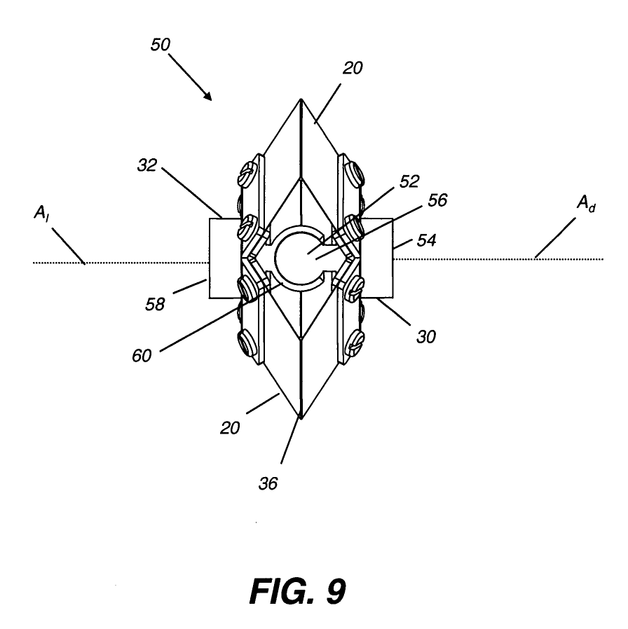

In some embodiments, there may be a need to constrain movement in specific directions. For example, FIG. 9 shows a folded flexure coupling 50 having an additional captive ball-and-socket joint 52 that constrains axial movement of flexure coupling 50 between drive and load members 30 and 32 to handle compressive forces, but still provides good wind-up stiffness. For the specific example of FIG. 9, a drive hub 54 is coupled to a ball member 56; a load hub 58 has a complementary socket member 60. With constraint from captive ball-and-socket joint 52, folded flexure coupling 50 would provide behavior generally equivalent to that of a conventional Cardan coupling.

For maximum wind-up stiffness and long life, folded sheet flexures 20 are typically made of sheet metal, such as spring steel. Other types of sheet materials that are stiff to forces along the plane of the sheet material but flexible to forces orthogonal to the plane of the sheet material could be used. Folded sheet flexures 20, although shown and described hereinabove as formed from flat sheets of metal or other material, may be fabricated in a number of alternate forms and could be patterned in a number of ways. A skeletal structure could even be formed to provide the function of folded sheet flexures 20 without using flat sheets. However, such a structure may lack the necessary rigidity and robustness needed in a specific application.

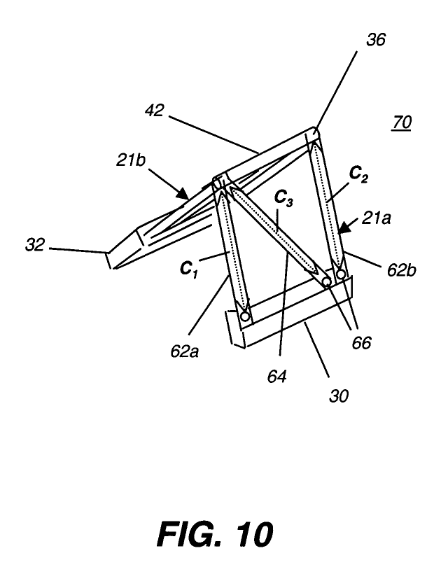

A general discussion of sheet flexure behavior, characteristics, and design is given in Exact Constraint: Machine Design Using Kinematic Principles by Douglass L. Blanding, ASME Press, New York, N.Y., 1999, pp. 62-68. From this reference, the general concept of a “sheet flexure equivalent” can be inferred by one skilled in the mechanical arts. For example, a “planar” flexure that exhibits behavior that is equivalent to that of a sheet flexure can be formed using a skeletal arrangement of thin bars or wires extended between two surfaces or other support members. For such an arrangement, two bars or wires would extend between the two surfaces or support members, with the bars or wires generally parallel to each other, thereby defining a plane. The third bar or wire would be in the same plane as the other two bars or wires, but would be diagonally disposed relative to the two parallel bars or wires. In the notation used in the Blanding text cited above, a sheet flexure equivalent would have two parallel constraints C₁, C₂ that define a plane and a third constraint C₃ that is in the same plane and is at a diagonal with respect to parallel constraints C₁, and C₂. As is shown in the perspective view of FIG. 10, a coupling using these equivalent structures would have a plurality of hinged two sheet flexure equivalent members 70. Each sheet flexure-equivalent member 70 has a first sheet equivalent structure 21a that extends between drive member 30 and fold 36 and a second sheet equivalent structure 21b that extends between load member 32 and fold 36. At fold 36 is a hinge 42 mechanism. Each sheet equivalent structure 21a, 21b has at least two parallel, linearly elongated members 62a and 62b that extend from hinge 42 to drive or load member 30 or 32 respectively. In the same plane as that defined by parallel, linearly elongated members 62a and 62b is a third linearly elongated member 64, disposed generally at a diagonal with respect to parallel, linearly elongated members 62a and 62b. Linearly elongated members 62a, 62b, 64 may be wires or bars, for example, depending on size, weight, and rigidity requirements. As shown in FIG. 10, following the convention used in the Blanding text noted above, linearly elongated members 62a, 62b, 64 provide the corresponding linear constraints C₁, C₂ and C₃. Fasteners 66 are used for attaching two sheet flexure equivalent members 70 at both drive and load members 30 and 32. A drawback with such an arrangement would be the need for additional fastening hardware and for some type of hinge 42. However, useful embodiments using flexure coupling 40 with such sheet equivalent structures 21 a, 21b can be envisioned.

Any of numerous arrangements of attachment hardware could be used at either end of folded sheet flexure 20, with any of a number of configurations of plates, fixtures, mounting components and fasteners, and bonding methods, for example.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, while optimal performance of folded sheet flexure coupling 40 is obtained when the arrangement of folded sheet flexures 20 meets the geometric requirements described above with reference to FIGS. 4 through 6, some tolerance for error and misalignment is permissible, with corresponding degradation of performance. For example, all of the folds 36 for flexure coupling 40 may not be exactly coplanar in a specific instance. In such a case, CV performance would be compromised, but wind-up stiffness would be maintained. Embodiments shown and described herein use three folded sheet flexures 20, advantageously forming a triangular arrangement. However, flexure coupling 40 could be formed using three, four, or any larger number of individual sheet flexures 20.

The apparatus and method of the present invention provide a coupling solution that is relatively simple, lightweight, easy to implement, and inexpensive, providing constant velocity operation over a range of angular offsets between the drive and load elements. Thus, what is provided is an apparatus and method for coupling a drive member to a load member with high wind-up stiffness, wherein variable axial alignment between drive and load members is possible.

### PARTS LIST

10 coupling apparatus
20 folded sheet flexure
21a sheet equivalent structure
21b sheet equivalent structure
22 plate
24 plate
28 screw
30 drive member
32 load member
36 fold
40 flexure coupling
42 hinge
50 flexure coupling
52 ball-and-socket joint
54 drive hub
56 ball member
58 load hub
60 socket member
62a linearly elongated member
62b linearly elongated member
64 linearly elongated member
66 fastener
70 two-sheet flexure equivalent member

1. A coupling between a drive member and a load member, the coupling comprising:
a plurality of folded sheet flexures, wherein each folded sheet flexure is:
i) coupled to the drive member on one side of a fold; and
ii) coupled to the load member on the opposite side of the fold.

2. A coupling according to claim 1 wherein said folds for the plurality of folded sheet flexures are substantially coplanar in a plane orthogonal to an axis between the drive member and the load member.

3. A coupling according to claim 2 wherein each said fold lies substantially along a tangent to a circle in said plane, said circle being substantially centered about the axis.

4. A coupling according to claim 1 comprising three folded sheet flexures.

5. A coupling according to claim 1 wherein the sheet flexures are comprised of sheet metal.

6. A coupling according to claim 1 wherein at least one of the sheet flexures comprises a hinge.

7. A coupling according to claim 1 wherein at least one of the folded sheet flexures is formed by an attachment of two or more separate pieces of sheet material.

8. A coupling according to claim 7 wherein the attachment is made at the fold.

9. A coupling according to claim 1 wherein at least one of the folded sheet flexures comprises first and second sheet-equivalent structures coupled at a hinge and wherein:
a) the first sheet-equivalent structure comprises a plurality of longitudinally extended members, each longitudinally extended member coupled to the hinge at one end and to the load member at the other end; and
b) the second sheet-equivalent structure comprises a plurality of longitudinally extended members, each longitudinally extended member coupled to the hinge at one end and to the drive member at the other end.

10. A coupling according to claim 9 wherein at least one of the longitudinally extended members is a wire.

11. A coupling between a drive member and a load member, the coupling comprising:
a plurality of folded sheet flexures, wherein each folded sheet flexure is:
i) coupled to the drive member on one side of a fold;
ii) coupled to the load member on the opposite side of the fold; and
wherein said folds for the plurality of folded sheet flexures are substantially coplanar in a plane orthogonal to an axis between the drive member and the load member, and wherein each said fold lies substantially along a tangent to a circle in said plane.

12. A coupling according to claim 11 wherein the coupling comprises three folded sheet flexures.

13. A coupling according to claim 11 wherein at least one of the sheet flexures comprises a hinge.

14. A coupling between a drive member and a load member, the coupling comprising:
a plurality of folded sheet flexures, wherein each folded sheet flexure is:
i) coupled to the drive member on one side of a fold;
ii) coupled to the load member on the opposite side of the fold;
wherein said folds for the plurality of folded sheet flexures are substantially coplanar in a plane orthogonal to an axis between the drive member and the load member, and wherein each said fold lies substantially along a tangent to a circle in said plane; and
iii) a ball-and-socket element fitted between the drive member and the load member to constrain axial displacement of the drive member relative to the load member.

15. A coupling according to claim 14 wherein the ball-and-socket element is magnetically attracted within the coupling.

16. A coupling according to claim 14 wherein at least one of the sheet flexures comprises a hinge.

17. A coupling according to claim 14 wherein a ball and socket joint comprises the spherical member.

18. A constant velocity coupling comprising a plurality of folded sheet flexures, wherein each folded sheet flexure is:
i) coupled to a drive shaft on one side of a fold; and
ii) coupled to a load shaft on the opposite side of the fold;
wherein said folds for the plurality of folded sheet flexures are substantially coplanar in a plane orthogonal to an axis between the drive shaft and load shaft, and wherein each said fold lies substantially along a tangent to a circle in said plane.

19. A coupling between a drive member and a load member, the coupling comprising:
a plurality of flexures, wherein each flexure comprises:
a) a first sheet equivalent structure extending from the drive member to a fold;
b) a second sheet equivalent structure extending from the load member to the fold;
wherein the first and second sheet equivalent structures are hinged to each other at the fold and
wherein each first and second sheet equivalent structure comprises:
(i) at least two parallel linearly elongated members extending between the fold and the drive or load member, respectively, the at least two parallel linearly elongated members defining a plane; and
(ii) a third linearly elongated member in the plane defined by the at least two parallel linearly elongated members, extending between the fold and the drive or load member, respectively, and generally at a diagonal relative to the at least two parallel linearly elongated members.

20. A method for coupling a drive member and a load member about an axis between drive and load members, the method comprising the step of extending a plurality of folded sheet flexures between the drive and load members with the steps of:
i) coupling each folded sheet flexure to the drive member on one side of a fold;
ii) coupling each folded sheet flexure to the load member on the opposite side of the fold; and
for each of the plurality of folded sheet flexures, aligning the folds to be substantially coplanar in a plane substantially orthogonal to the axis between drive and load members, such that each fold lies substantially along a tangent to a circle within said plane.

21. A method according to claim 20 wherein the step of coupling each folded sheet flexure to the drive member comprises the step of affixing a fastener.
